(19) United States
(12) Patent Application Publication
(10) Pub. No.: US 2026/0186659 A1
(43) Pub. Date: Jul. 2, 2026

(54) REORDERED PAGE MAPPING FOR TRIPLE LEVEL MEMORY CELLS

(71) Applicant: Micron Technology, Inc., Boise, ID (US)

(72) Inventors: Wenjun Wu, Shanghai (CN); Deping He, Boise, ID (US); Xiaolai Zhu, Shanghai (CN)

(21) Appl. No.: 19/418,393

(22) Filed: Dec. 12, 2025

Related U.S. Application Data
(60) Provisional application No. 63/739,237, filed on Dec. 27, 2024.

(51) Int. Cl. G06F 3/06

(52) U.S. Cl. CPC G06F 3/0611; G06F 3/0659; G06F 3/0679

(57) ABSTRACT

Methods, systems, and devices for reordered page mapping for triple level memory cells are described. A memory system may map logical block addresses (LBAs) to page physical addresses (PPAs) according to a logical-to-physical (L2P) mapping scheme such that a low LBA may be mapped to an upper page of a tri-level cell (TLC). The memory device may receive a write command that includes data associated with a range of LBAs. The range of LBAs may include a lowest LBA and a highest LBA. The memory device may map the range of LBAs to one or more PPAs according to the L2P mapping scheme. The lowest LBA of the range of LBAs may be mapped to a first PPA associated with a UP of a TLC in accordance with the L2P mapping scheme. Then, the memory device may write the data to the TLC according to the L2P mapping scheme.

### CROSS REFERENCE

The present Application for Patent claims priority to U.S. Provisional Patent Application No. 63/739,237 by Wu et al., entitled “REORDERED PAGE MAPPING FOR TRIPLE LEVEL MEMORY CELLS,” filed Dec. 27, 2024, which is assigned to the assignee hereof, and which is expressly incorporated by reference in its entirety herein.

### TECHNICAL FIELD

The following relates to one or more systems for memory, including reordered page mapping for triple level memory cells.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports reordered page mapping for triple level memory cells in accordance with examples as disclosed herein.

FIG. 2A shows an example of a mapping scheme diagram that supports reordered page mapping for triple level memory cells in accordance with examples as disclosed herein.

FIG. 2B shows an example of a timing diagram that supports reordered page mapping for triple level memory cells in accordance with examples as disclosed herein.

FIG. 3 shows a block diagram of a memory system that supports reordered page mapping for triple level memory cells in accordance with examples as disclosed herein.

FIG. 4 shows a flowchart illustrating a method or methods that support reordered page mapping for triple level memory cells in accordance with examples as disclosed herein.

### DETAILED DESCRIPTION

In some memory systems, memory cell read times may be unequal among a set of page types. For example, a tri-level cell (TLC) may include a lower page (LP), an upper page (UP) and an extra page (XP). A read time of the UP may be longer than respective read times of the LP and the XP due to a distribution of logic states stored by the cell. For example, up to three read strobes may be used to detect a change in a bit associated with the UP, whereas up to two read strobes may be used to detect a change in bits associated with the LP and XP, respectively, which may increase the read time for the UP. Such unequal read times may result in increased idle times within a memory system while, for example, the UP is being read or the system is preparing to read the UP, which may waste resources and increase processing and latency. Thus, solutions to decrease idle times resulting from unequal read times for different page types within a memory cell may be beneficial.

Techniques, systems, and devices described herein provide for a logical-to-physical (L2P) mapping scheme used within a memory system to be modified to reduce idle times during reads while accounting for unequal read times across page types. For example, a memory system may map logical block addresses (LBAs) to page physical addresses (PPAs) according to the L2P mapping scheme described herein such that a lowest LBA within a range of LBAs associated with a given TLC may be mapped to a UP of the TLC. For example, the memory system may receive a write command that includes data associated with at least one range of LBAs. The range of LBAs may include at least a lowest LBA and a highest LBA within the range and may be stored to a same TLC. The memory system may store mapping information that maps the range of LBAs to one or more PPAs in response to the write command and in accordance with the L2P mapping scheme. The lowest LBA of the range of LBAs may be mapped to a first PPA associated with a UP of a memory cell (e.g., a TLC) in accordance with the L2P mapping scheme and in accordance with the UP being read prior to other page types of the memory cell during a read of the memory cell. The memory system may write the data to the memory cell in accordance with the write command and the one or more PPAs. The described mapping scheme may thereby provide for reduced latency and processing when reading the TLC.

In addition to applicability in memory systems as described herein, techniques for a reordered page mapping for triple level memory cells may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reordering a mapping sequence to map a UP first (e.g., to an LBA low bit), which may increase memory transfer efficiency in the context of reading data from memory cells and thus may decrease processing and latency times, among other benefits.

Features of the disclosure are illustrated and described in the context of systems, devices, and circuits. Features of the disclosure are further illustrated and described in the context of a mapping scheme diagram, a timing diagram, and flowcharts.

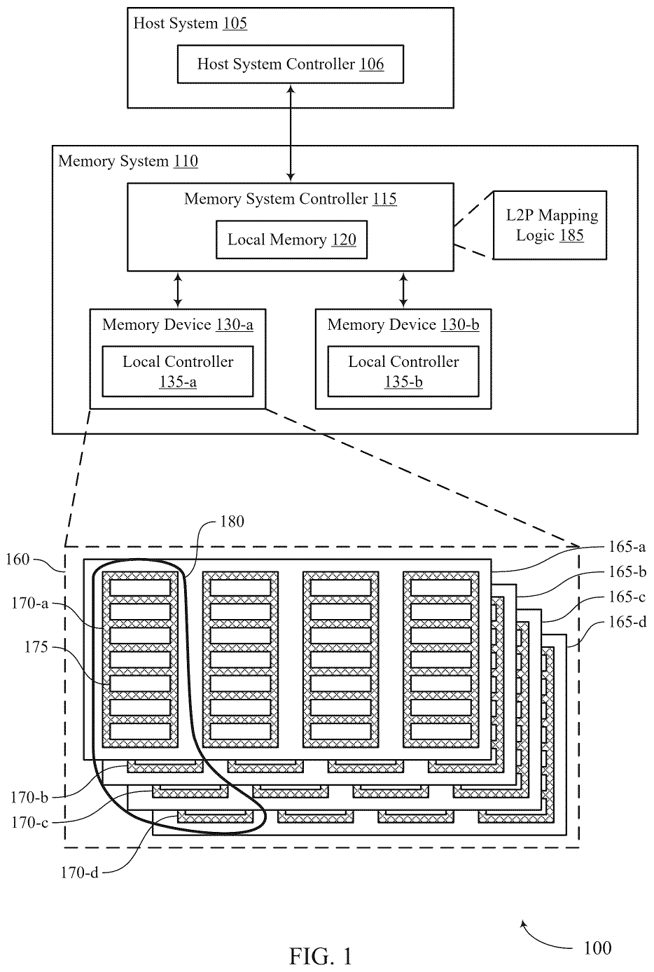

FIG. 1 shows an example of a system 100 that supports reordered page mapping for triple level memory cells in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as TLCs if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

Each memory cell may be programmed to store a logic value representing one or more bits of information. In some cases, a single memory cell—such as an SLC memory cell—may be programmed to one of two supported states and thus may store one bit of information at a time (e.g., a logic 0 or a logic 1). In other cases, a single memory cell—such as an MLC, TLC, QLC, or other type of multiple-level memory cell—may be programmed to one or more than two supported states and thus may store more than one bit of information at a time. In some examples, a single MLC memory cell may be programmed to one of four supported states and thus may store two bits of information at a time corresponding to one of four logic values (e.g., a logic 00, a logic 01, a logic 10, or a logic 11). In some examples, a single TLC memory cell may be programmed to one of eight supported states and thus may store three bits of information at a time corresponding to one of eight logic values (e.g., 000, 001, 010, 011, 100, 101, 110, or 111). In some examples, a single QLC memory cell may be programmed to one of sixteen supported states and thus may store four bits of information at a time corresponding to one of sixteen logic values (e.g., 0000, 0001, . . . 1111).

In some cases, a multiple-level memory cell (e.g., an MLC memory cell, a TLC memory cell, a QLC memory cell) may be physically different than an SLC cell. For example, a multiple-level memory cell may use a different cell geometry or may be fabricated using different materials. In some cases, a multiple-level memory cell may be physically the same or similar to an SLC cell, and other circuitry in a memory block (e.g., a controller, sense amplifiers, drivers) may be configured to operate (e.g., read and program) the memory cell as an SLC cell, or as an MLC cell, or as a TLC cell, etc.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Some memory systems may experience increased latency and reduced performance with multi-level cells (e.g., TLC performance) due to, for example, uneven read times across pages (e.g., bits) of the cells. For example, the UP of a TLC may be associated with a relatively longer read time than other page types. That is, a TLC read time (e.g., tRead) may not be the same for each of three page types. For example, a first read time corresponding to LP and a second read time corresponding to XP may be relatively short, while a third read time corresponding to UP may be relatively long (e.g., for a given TLC, the third read time may be around 10 microseconds slower than the first read time, the second read time, or both). The difference in read times may be a result of changes to TLC gray code schemes between generations of devices (e.g., since relatively older devices or protocols may use different gray code schemes than relatively newer devices or protocols).

Some memory systems may support a relatively fast interface (e.g., an open NAND flash interface (ONFI)), which may result in relatively fast read performance. However, an interface data transfer time of one multiplane page may be longer than the first read time (e.g., tRead for LP) and the second read time (e.g., tRead for XP), but may be shorter than the third read time (e.g., tRead for UP). That is, the data read from the LP and XP in a TLC may be transferred within the allocated transfer time, but the data read from the UP of the TLC may take a longer duration to transfer (e.g., due to increased read strobes for the UP, for example). Thus, an idle time may increase due to waiting for UP data to be ready in a cache register. Some memory systems may read data from another die during the idle time (e.g., to fill up the ONFI idle time), but this may require a relatively large buffer (e.g., hundreds of kilobytes) due to a relatively small memory cell layout (e.g., a small-z TLC layout).

Some memory systems may apply a first mapping scheme for mapping LBAs to TLC pages (e.g., according to an “original” mapping order). A memory system may apply the first mapping scheme by mapping an LBA low to an LP page, an LBA middle to a UP page, and an LBA high to an XP page, where the LBA low, LBA middle, and LBA high may refer to relative locations of the LBAs within a given LBA range. Thus, the first mapping scheme may be associated with a first mapping order.

Techniques described herein may support the memory system 110 to map LBAs to PPAs according to an L2P mapping scheme such that a low LBA may be mapped to a UP of a TLC. For example, the memory system 110 may include L2P mapping logic 185. The memory system 110 may use the L2P mapping logic 185 to map the LBAs to the PPAs according to the L2P mapping scheme. In some cases, the memory system 110 may receive (e.g., via the memory system controller 115) a write command that includes data associated with a range of LBAs. The range of LBAs may include at least a lowest LBA and a highest LBA within the range. The memory system 110 may store a mapping that maps, according to the L2P mapping logic 185, the range of LBAs to one or more PPAs in response to the write command and in accordance with the L2P mapping scheme (e.g., the L2P mapping logic 185 may include instructions to follow the L2P mapping scheme). The lowest LBA of the range of LBAs may be mapped to a first PPA associated with a UP of a memory cell (e.g., a TLC) in accordance with the L2P mapping scheme (e.g., using the L2P mapping logic 185) and in accordance with the UP being read prior to other page types of the memory cell during a read of the memory cell. The memory system 110 may write the data to the memory cell in accordance with the write command and the one or more PPAs.

The system 100 may include any quantity of non-transitory computer readable media that support reordered page mapping for triple level memory cells. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

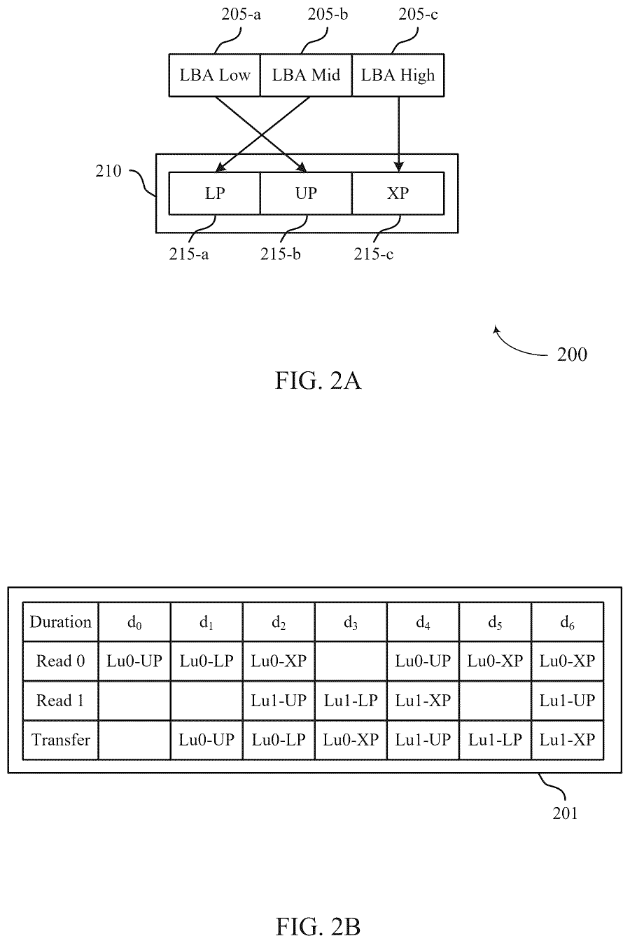

FIG. 2A shows an example of a mapping scheme diagram 200 that supports reordered page mapping for triple level memory cells in accordance with examples as disclosed herein. The mapping scheme diagram includes a set of LBAs 205, which may be referred to as a range of LBAs. For example, the set of LBAs 205 may include an LBA low 205-a (e.g., a “lowest” LBA within the range), an LBA mid 205-b (e.g., a “middle” LBA within the range), and an LBA high 205-c (e.g., a “highest” LBA within the range). The mapping scheme diagram also includes a memory cell 210, which may be an example of a TLC configured to store three logic levels. The memory cell 210 may include a set of pages, and each page of the set of pages may be associated with a respective page type. For example, the memory cell 210 may include an LP 215-a, a UP 215-b, and an XP 215-c. In some cases, aspects of the mapping scheme diagram 200 may implement or may be implemented by the system 100 as described with reference to FIG. 1. For example, a memory system 110 may use a memory system controller 115, including L2P mapping logic 185, to map data according to a mapping scheme as depicted in the mapping scheme diagram 200.

Different voltages applied to the memory cell 210 may determine different logic states (e.g., of eight candidate logic states, for example). For example, the memory cell 210 may be associated with seven replacement gates (e.g., R0 through R7), which may be activated via application of unique voltage levels. According to the examples disclosed herein, a unit-distance code such as a gray code is used to map the different states of the tri-level memory cell 210. The gray code mapping is a representation, such as a binary representation, where only one bit changes for each increment or decrement in value. For example, a single bit change occurs when transitioning from a first state to a third state (e.g., 000 to 010 or 111 to 110) and vice versa. The threshold voltages can be mapped to one of 2^{X} levels, where X represents the quantity of bits used to store information in the memory cell 210. Accordingly, a three bit gray code can be used to map the eight different logic states of the memory cell 210.

The memory cell 210 may use different types of pages for storing information. According to an example, memory cell 210 may be a tri-layer memory cell that stores three bits of data. Each bit of data may be included in a respective page (e.g., XP, UP, and LP). Each memory cell may include a set of word lines that correspond to a respective set of at least three pages (e.g., a XP, UP, and LP). Each word line may be coupled with a respective set of memory cells, each memory cell may be operable to store at least three bits of information. Each of the three bits may be included in a respective page of the respective set of at least three pages. In some examples, the most significant bit (MSB) may be included in an XP, the second MSB may be included in a UP, and the third MSB, which may be the least significant bit (LSB), may be included in an LP (e.g., according to the gray code).

A quantity of read strobes required to decode the bits for a particular state of the memory cell 210 may vary based upon the specific gray code used to encode the states as well as the page type being read. In some examples described herein, the memory cell 210 is encoded in accordance with a gray code of 2-3-2 (going from LSB to MSB). Such a memory cell 210 may require two strobes to decode the bit corresponding to each of the XP 215-c and the LP 215-a, and three strobes to decode the bit corresponding to the UP 215-b. The resulting states may be encoded with the following eight logic states: 111, 110, 100, 000, 010, 011, 001, 101. To detect whether a bit associated with the UP 215-b has changed, up to three read strobes may be applied in accordance with the described gray code to, for example, determine whether the corresponding logic state is below a first threshold voltage (e.g., either logic state 111 or logic state 110), between the first threshold voltage and a second threshold voltage (e.g., either logic state 100 or logic state 000) or above the second threshold voltage (e.g., either logic state 001 or logic state 101). Up to two read strobes may be applied to detect a change in the LP 215-a or the XP 215-c.

Such a distribution may provide for a relatively more even distribution of read times (e.g., tR) and block error rates across the page types as compared with other gray codes such as a 1-2-4 code (going from LSB to MSB). However, the 2-3-2 gray code may increase a time for reading the UP 215-b (e.g., more time to read the UP 215-b than the LP 215-a and the XP 215-c) due to, for example, the need for additional read strobes to detect the change in the UP 215-b as compared with the LP 215-a and the XP 215-c. In some memory systems, program operations to write data to memory cells within the memory system may map a lowest LBA within an LBA range to the LP 215-a, and a highest LBA to the XP 215-c. The data may be read from the memory cell 210 according to the page type order (e.g., LP, UP, XP). As such, there may be an increased idle time for reading the UP 215-b between the read of the LP 215-a and the XP 215-c, which may be relatively inefficient.

Techniques, systems, and devices described herein provide for a reordered mapping of the LBAs to the page types within a memory cell 210, such that the UP 215-b may be read first (e.g., before the LP 215-a and the XP 215-c) during a read operation to reduce an overall read duration and idle times within the memory system 110. As described herein, the memory system 110 may store mapping information (e.g., an L2P table) that maps the set of LBAs 205 to pages of the memory cell 210 according to the mapping scheme as illustrated in the mapping scheme diagram 200. The mapping scheme may be referred to as a reordered mapping scheme in some examples herein. For example, the memory system 110 may map the LBA low 205-a to the UP 215-b. In some cases, the memory system 110 may map the LBA mid 205-b to the LP 215-a, and may map the LBA high 205-c to the XP 215-c. In some other cases, the memory system 110 may map the LBA mid 205-b to the XP 215-c, and may map the LBA high 205-c to the LP 215-a.

In some implementations, a flash translation layer (FTL) of the memory system may perform one or more procedures associated with the mapping scheme. In some cases, the memory system controller 115 may perform the one or more procedures (e.g., the FTL may be a part of the memory system controller 115). The FTL may manage a set of pages by PPA, which may be a logical NAND page address. In some examples, a PPA may be continuous within a super block of memory. The FTL may map one or more PPAs to one or more NAND page types (e.g., an LP, UP, or XP) freely. Thus, according to the mapping scheme described herein, the FTL may modify a mapping relation of the one or more PPAs associated with the one or more NAND page types (e.g., modifying the mapping relation such that the LBA low 205-a is mapped to a PPA associated with the UP 215-b, and so on).

In some cases, during a write (e.g., a host write, a garbage collection write, or both), the FTL may receive a set of data (e.g., with LBAs) in an original order (e.g., where LBA low 205-a is ordered first, LBA mid 205-b is ordered second, and LBA high 205-c is ordered third). Then, the FTL may allocate the set of data to respective PPAs sequentially. For example, the FTL may allocate a first PPA for the LBA low 205-a, a second PPA for the LBA mid 205-b, and a third PPA for the LBA high 205-c. In some implementations, the FTL may store mapping information that indicates the LBA to PPA mapping at a memory device 130-a or other storage location. The FTL may thereby map the LBAs to PPAs sequentially, in some examples, and may subsequently map each LBA 205 of the set of LBAs 205 to a respective page 215 according to a first sequence, ordered UP 215-b, LP 215-a, followed by XP 215-c. In some cases, the first sequence may be UP 215-b, XP 215-c, followed by LP 215-a. Finally, the FTL may write (e.g., program) the set of data at the memory cell 210 according to the mapping scheme and the first sequence. For example, the FTL may write the set of data to the UP 215-b, to the LP 215-a, and to the XP 215-c together (e.g., according to a write to a TLC). Writing the set of data to the memory cell 210 may be according to the mapping scheme as described herein.

In some implementations, the FTL may perform garbage collection and refresh operations without regard for the mapping scheme (e.g., garbage collection and refresh may not be impacted, since the read sequence remains unchanged for the PPA allocation sequence, which aligns with the data write sequence). That is, if an original data source is sequentially programed, then after garbage collection, the data may still be sequential in a destination block. As described herein, garbage collection may refer to a process of reprogramming valid data from an old block into a new block and erasing all data in the old block simultaneously. Refresh may refer to an operation that extends retention time of memory, and may include reading, correcting, and rewriting data to a memory block.

In some cases, the memory system controller 115 (e.g., a backend of the memory system 110) may perform one or more operations. For example, the memory system controller 115 may transmit (e.g., send) a command to the memory device 130-a (e.g., the NAND) to write data according to a second sequence. The second sequence may include the LP 215-a first, the UP 215-b second, and the XP 215-c third (e.g., due to a configuration of the NAND command interface). That is, the memory device 130-a may not support the order associated with the updating mapping scheme described herein when writing the data to memory, in some examples. In such cases, if the FTL sends a write command according to a PPA order (e.g., according to the first sequence of the updated mapping scheme), the memory system controller 115 may reorder the command and transmit the command to the memory device 130-a according to the second sequence (e.g., the second sequence may be a reordered sequence corresponding to the first sequence).

FIG. 2B shows an example of a timing diagram 201 that supports reordered page mapping for triple level memory cells in accordance with examples as disclosed herein. In some cases, aspects of the timing diagram 201 may implement or may be implemented by the system 100. For example, a memory system 110 may perform a set of operations as illustrated in the timing diagram 201. The timing diagram 201 includes a set of rows that illustrate the set of operations, and the memory system 110 may perform the set of operations during a set of durations (e.g., d₀, d₁, d₂, and so on). For example, a first row (e.g., a “Read 0” row) may represent a first set of reads at a first die of the memory system 110. A second row (e.g., a “Read 1” row) may represent a second set of reads at a second die of the memory system 110. A third row (e.g., a “Transfer” row) may represent a set of transfer operations for transferring the data from the respective dies at the memory system 110.

In some implementations (e.g., for an 8DIE device or more), one channel (e.g., ONFI) may be coupled with two dies (e.g., DIE0, DIE1). As such, by updating the mapping scheme as described herein, the memory system 110 may read data from a second die during an idle time of a first die (e.g., overlapping the UP tRead idle window). A mapping scheme (e.g., the mapping scheme described with reference to FIG. 2A) may reduce an amount of buffer used for a pre-read since the second die read data may not be transferred before a read at the first die is complete. In some cases, the mapping scheme may define a mapping order that modifies an UP of the second die (e.g., DIE1) to be a pre-read page, which may be read in a threshold buffer idle time (e.g., a minimum buffer idle time). Thus, the mapping scheme may support utilizing (e.g., filling) a TLC ONFI idle window without using extra buffer space.

The memory system 110 may read data according to a sequential read order (e.g., LBA low first, LBA middle second, and LBA high third). Thus, in accordance with the updated LBA to page mapping scheme described herein, the memory system 110 may perform a first read 0 (e.g., in response to a read command). The first read 0 may include reading a UP of the first die during d₀, an LP of the first die during d₁, and an XP of the first die during d₂. The data read from the UP of the first die may be ready for transfer via the memory channel during d₁. In some examples, the read of the UP may occur at least two transfer durations before d₁ (e.g., during a duration before d₀, not pictured in FIG. 2B). That is, the transfer time for the UP may be at least two transfer durations, which may be longer than a transfer time for the XP or LP (e.g., one transfer duration). In this example, the memory system 110 may perform a transfer of the UP data during d₁, a transfer of the LP data during d₂, and a transfer of the XP data during d₃. Since a UP read time may be relatively long compared to an XP read time or an LP read time, reading the UP first (e.g., during d₀) and transferring the UP at a duration at least partially overlapping with the read of the LP (e.g., transferring the UP and reading the LP during d₁) may expedite the performance of overall read and transfer timing at the memory system 110.

The reduced latency of such a read order may be shown on subsequent consecutive reads. For example, the memory system 110 may perform a second read 1 (e.g., in response to a read command) at least partially overlapping with the first read 0. The second read 1 may include reading a UP of the second die during d₂ (e.g., overlapping, or at least partially concurrently, with the read of the XP of the first die), reading an LP of the second die during d₃, and reading an XP of the second die during d₄. The data read at the UP of the second die may be ready for transfer after two read durations, such that the data may be ready for transfer during d₄, which may be a next duration immediately after the duration d₃ in which the pages of the first die are finished being transferred via the shared channel. That is, the memory system 110 may perform a transfer of the UP data of the second die during d₄, a transfer of the LP data of the second die during d₅, and a transfer of the XP data of the second die during d₆. Transferring one page of the first die (e.g., the Lu0-LP or the Lu0-XP) at a duration at least partially overlapping with the read of the UP of the second die (e.g., transferring Lu0-LP and reading the Lu1-UP during d₂) may expedite the performance of overall read and transfer timing at the memory system 110. For example, since the UP has a longer read time than the LP or the XP, transferring the LP and the XP concurrently with reading the UP may give the memory system 110 sufficient time to read the UP of the second die before the UP is to be transferred. That is, the mapping scheme described herein (e.g., described with reference to FIG. 2A) may support the memory system 110 to perform data reads and transfers with increased efficiency as compared with systems in which there is an idle duration after a read of the UP to support the extra UP read times before other reads can proceed.

The memory system 110 may perform further operations (e.g., further reads and transfers) accordingly. Thus, the memory system 110 may reduce idle time of the ONFI channels by reordering a memory cell page mapping according to the mapping scheme as described herein, thereby resulting in increased read and transfer efficiency at the memory system 110. That is, the timing diagram 201 may illustrate how the mapping scheme results in increased read and transfer efficiency at the memory system 110. For example, since the mapping scheme results in the LBA low mapping to the UP, the memory system 110 may accordingly perform a read on the UP first (e.g., before other pages of a TLC). This may result in the advantages described herein, including increased read and transfer efficiency at the memory system 110.

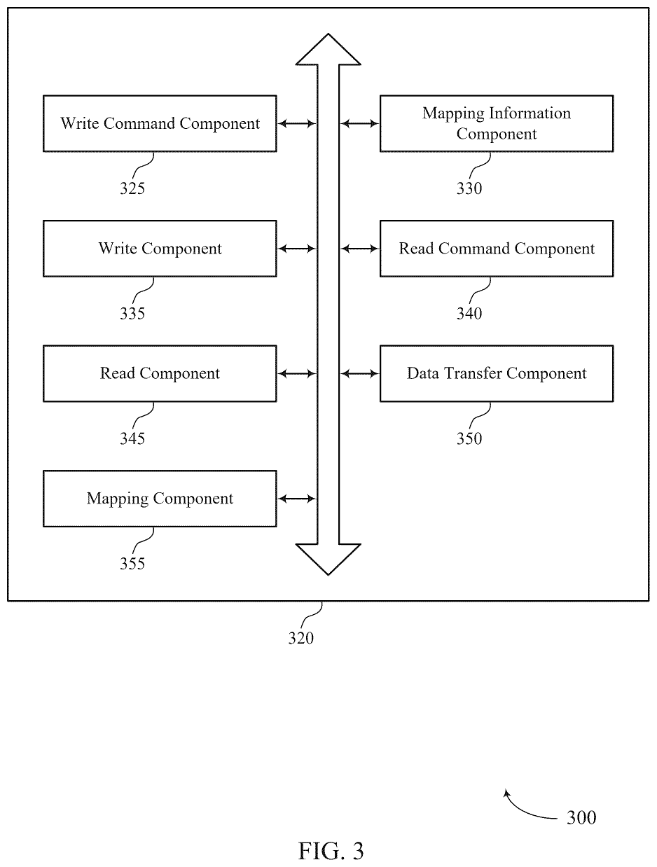

FIG. 3 shows a block diagram 300 of a memory system 320 that supports reordered page mapping for triple level memory cells in accordance with examples as disclosed herein. The memory system 320 may be an example of aspects of a memory system as described with reference to FIGS. 1 through 2. The memory system 320, or various components thereof, may be an example of means for performing various aspects of reordered page mapping for triple level memory cells as described herein. For example, the memory system 320 may include a write command component 325, a mapping information component 330, a write component 335, a read command component 340, a read component 345, a data transfer component 350, a mapping component 355, or any combination thereof. Each of these components, or components of subcomponents thereof (e.g., one or more processors, one or more memories), may communicate, directly or indirectly, with one another (e.g., via one or more buses).

The write command component 325 may be configured as or otherwise support a means for receiving a write command including data associated with a range of logical block addresses, the range of logical block addresses including a lowest logical block address within the range of logical block addresses and a highest logical block address within the range of logical block addresses. The mapping information component 330 may be configured as or otherwise support a means for storing, in response to the write command and in accordance with a logical-to-physical mapping scheme, mapping information that maps the range of logical block addresses to one or more page physical addresses, where the lowest logical block address is mapped to a first page physical address associated with an upper page of a memory cell in accordance with the logical-to-physical mapping scheme and in accordance with the upper page being read prior to other page types of the memory cell during a read of the memory cell. The write component 335 may be configured as or otherwise support a means for writing the data to the memory cell in accordance with the write command and the one or more page physical addresses.

In some examples, the read command component 340 may be configured as or otherwise support a means for receiving a read command that indicates the range of logical block addresses associated with the data stored in the memory cell. In some examples, the read component 345 may be configured as or otherwise support a means for reading, at a first time and in accordance with the range of logical block addresses indicated via the read command, a first data bit from the upper page of the memory cell in accordance with the upper page being mapped to the lowest logical block address of the range of logical block addresses. In some examples, the data transfer component 350 may be configured as or otherwise support a means for transferring, from a second memory cell at the first time, one or more second data bits corresponding to the other page types of the second memory cell, where the one or more second data bits are transferred from the second memory cell at least partially concurrently with reading the first data bit from the memory cell. In some examples, the data transfer component 350 may be configured as or otherwise support a means for transferring the first data bit from the memory cell after transferring the one or more second data bits from the second memory cell in accordance with reading the first data bit.

In some examples, the read component 345 may be configured as or otherwise support a means for reading, prior to the first time, a third data bit corresponding to an upper page of the second memory cell. In some examples, the data transfer component 350 may be configured as or otherwise support a means for transferring, from the second memory cell and prior to the first time, the third data bit corresponding to the upper page of the second memory cell. In some examples, the read component 345 may be configured as or otherwise support a means for reading the one or more second data bits corresponding to the other page types of the second memory cell, where transferring the one or more second data bits is in accordance with reading the one or more second data bits, and where the one or more second data bits are read at least partially concurrently with reading the first data bit from the memory cell and at least partially concurrently with transferring the third data bit.

In some examples, the mapping information component 330 may be configured as or otherwise support a means for retrieving, in accordance with the read command, the mapping information, where reading the first data bit from the upper page is in accordance with the mapping information indicating that the lowest logical block address of the range of logical block addresses is mapped to a page physical address of the upper page.

In some examples, the memory cell is located on a first die of a memory system and the second memory cell is located on a second die of the memory system.

In some examples, to support writing the data to the memory cell, the write component 335 may be configured as or otherwise support a means for writing the data to the memory cell in accordance with an ordered sequence of page types supported by the memory cell, where the ordered sequence of page types is different from an order of the one or more page physical addresses.

In some examples, the ordered sequence of page types indicates a write to a lower page of the memory cell first, a write to the upper page of the memory cell after the write to the lower page, and a write to an extra page of the memory cell after the writes to the lower page and the upper page.

In some examples, the mapping component 355 may be configured as or otherwise support a means for mapping, in accordance with the logical-to-physical mapping scheme, a middle logical block address of the range of logical block addresses to a second page physical address associated with a lower page of the memory cell. In some examples, the mapping component 355 may be configured as or otherwise support a means for mapping, in accordance with the logical-to-physical mapping scheme, the highest logical block address of the range of logical block addresses to a third page physical address associated with an extra page of the memory cell, where storing the mapping information is in accordance with mapping the middle logical block address and the highest logical block address.

In some examples, the mapping component 355 may be configured as or otherwise support a means for mapping, in accordance with the logical-to-physical mapping scheme, the highest logical block address of the range of logical block addresses to a second page physical address associated with a lower page of the memory cell. In some examples, the mapping component 355 may be configured as or otherwise support a means for mapping, in accordance with the logical-to-physical mapping scheme, a middle logical block address of the range of logical block addresses to a third page physical address associated with an extra page of the memory cell, where storing the mapping information is in accordance with mapping the middle logical block address and the highest logical block address.

In some examples, the memory cell includes a triple level memory cell that stores an upper page bit, a lower page bit, and an extra page bit.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

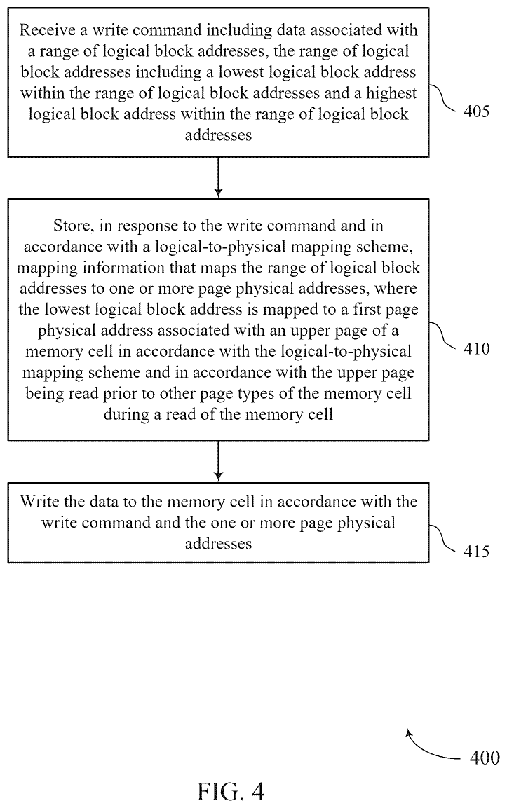

FIG. 4 shows a flowchart illustrating a process 400 that supports reordered page mapping for triple level memory cells in accordance with examples as disclosed herein. The operations of process 400 may be implemented by a memory system or its components as described herein. For example, the operations of process 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the process may include receiving a write command including data associated with a range of logical block addresses, the range of logical block addresses including a lowest logical block address within the range of logical block addresses and a highest logical block address within the range of logical block addresses. In some examples, aspects of the operations of 405 may be performed by a write command component 325 as described with reference to FIG. 3.

At 410, the process may include storing, in response to the write command and in accordance with a logical-to-physical mapping scheme, mapping information that maps the range of logical block addresses to one or more page physical addresses, where the lowest logical block address is mapped to a first page physical address associated with an upper page of a memory cell in accordance with the logical-to-physical mapping scheme and in accordance with the upper page being read prior to other page types of the memory cell during a read of the memory cell. In some examples, aspects of the operations of 410 may be performed by a mapping information component 330 as described with reference to FIG. 3.

At 415, the process may include writing the data to the memory cell in accordance with the write command and the one or more page physical addresses. In some examples, aspects of the operations of 415 may be performed by a write component 335 as described with reference to FIG. 3.

In some examples, an apparatus as described herein may perform a process or processes, such as the process 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command including data associated with a range of logical block addresses, the range of logical block addresses including a lowest logical block address within the range of logical block addresses and a highest logical block address within the range of logical block addresses; storing, in response to the write command and in accordance with a logical-to-physical mapping scheme, mapping information that maps the range of logical block addresses to one or more page physical addresses, where the lowest logical block address is mapped to a first page physical address associated with an upper page of a memory cell in accordance with the logical-to-physical mapping scheme and in accordance with the upper page being read prior to other page types of the memory cell during a read of the memory cell; and writing the data to the memory cell in accordance with the write command and the one or more page physical addresses.

Aspect 2: The method, apparatus, or non-transitory computer-readable medium of aspect 1, further including operations, features, circuitry, logic, means, or instructions, or any combination thereof for receiving a read command that indicates the range of logical block addresses associated with the data stored in the memory cell; reading, at a first time and in accordance with the range of logical block addresses indicated via the read command, a first data bit from the upper page of the memory cell in accordance with the upper page being mapped to the lowest logical block address of the range of logical block addresses; transferring, from a second memory cell at the first time, one or more second data bits corresponding to the other page types of the second memory cell, where the one or more second data bits are transferred from the second memory cell at least partially concurrently with reading the first data bit from the memory cell; and transferring the first data bit from the memory cell after transferring the one or more second data bits from the second memory cell in accordance with reading the first data bit.

Aspect 3: The method, apparatus, or non-transitory computer-readable medium of aspect 2, further including operations, features, circuitry, logic, means, or instructions, or any combination thereof for reading, prior to the first time, a third data bit corresponding to an upper page of the second memory cell; transferring, from the second memory cell and prior to the first time, the third data bit corresponding to the upper page of the second memory cell; and reading the one or more second data bits corresponding to the other page types of the second memory cell, where transferring the one or more second data bits is in accordance with reading the one or more second data bits, and where the one or more second data bits are read at least partially concurrently with reading the first data bit from the memory cell and at least partially concurrently with transferring the third data bit.

Aspect 4: The method, apparatus, or non-transitory computer-readable medium of any of aspects 2 through 3, further including operations, features, circuitry, logic, means, or instructions, or any combination thereof for retrieving, in accordance with the read command, the mapping information, where reading the first data bit from the upper page is in accordance with the mapping information indicating that the lowest logical block address of the range of logical block addresses is mapped to a page physical address of the upper page.

Aspect 5: The method, apparatus, or non-transitory computer-readable medium of any of aspects 2 through 4, where the memory cell is located on a first die of a memory system and the second memory cell is located on a second die of the memory system.

Aspect 6: The method, apparatus, or non-transitory computer-readable medium of any of aspects 1 through 5, where writing the data to the memory cell includes operations, features, circuitry, logic, means, or instructions, or any combination thereof for writing the data to the memory cell in accordance with an ordered sequence of page types supported by the memory cell, where the ordered sequence of page types is different from an order of the one or more page physical addresses.

Aspect 7: The method, apparatus, or non-transitory computer-readable medium of aspect 6, where the ordered sequence of page types indicates a write to a lower page of the memory cell first, a write to the upper page of the memory cell after the write to the lower page, and a write to an extra page of the memory cell after the writes to the lower page and the upper page.

Aspect 8: The method, apparatus, or non-transitory computer-readable medium of any of aspects 1 through 7, further including operations, features, circuitry, logic, means, or instructions, or any combination thereof for mapping, in accordance with the logical-to-physical mapping scheme, a middle logical block address of the range of logical block addresses to a second page physical address associated with a lower page of the memory cell and mapping, in accordance with the logical-to-physical mapping scheme, the highest logical block address of the range of logical block addresses to a third page physical address associated with an extra page of the memory cell, where storing the mapping information is in accordance with mapping the middle logical block address and the highest logical block address.

Aspect 9: The method, apparatus, or non-transitory computer-readable medium of any of aspects 1 through 8, further including operations, features, circuitry, logic, means, or instructions, or any combination thereof for mapping, in accordance with the logical-to-physical mapping scheme, the highest logical block address of the range of logical block addresses to a second page physical address associated with a lower page of the memory cell and mapping, in accordance with the logical-to-physical mapping scheme, a middle logical block address of the range of logical block addresses to a third page physical address associated with an extra page of the memory cell, where storing the mapping information is in accordance with mapping the middle logical block address and the highest logical block address.

Aspect 10: The method, apparatus, or non-transitory computer-readable medium of any of aspects 1 through 9, where the memory cell includes a triple level memory cell that stores an upper page bit, a lower page bit, and an extra page bit.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command comprising data associated with a range of logical block addresses, the range of logical block addresses comprising a lowest logical block address within the range of logical block addresses and a highest logical block address within the range of logical block addresses;
store, in response to the write command and in accordance with a logical-to-physical mapping scheme, mapping information that maps the range of logical block addresses to one or more page physical addresses, wherein the lowest logical block address is mapped to a first page physical address associated with an upper page of a memory cell in accordance with the logical-to-physical mapping scheme and in accordance with the upper page being read prior to other page types of the memory cell during a read of the memory cell; and
write the data to the memory cell in accordance with the write command and the one or more page physical addresses.

2. The memory system of claim 1, wherein the processing circuitry is further configured to cause the memory system to:
receive a read command that indicates the range of logical block addresses associated with the data stored in the memory cell;
read, at a first time and in accordance with the range of logical block addresses indicated via the read command, a first data bit from the upper page of the memory cell in accordance with the upper page being mapped to the lowest logical block address of the range of logical block addresses;
transfer, from a second memory cell at the first time, one or more second data bits corresponding to the other page types of the second memory cell, wherein the one or more second data bits are transferred from the second memory cell at least partially concurrently with reading the first data bit from the memory cell; and
transfer the first data bit from the memory cell after transferring the one or more second data bits from the second memory cell in accordance with reading the first data bit.

3. The memory system of claim 2, wherein the processing circuitry is further configured to cause the memory system to:
read, prior to the first time, a third data bit corresponding to an upper page of the second memory cell;
transfer, from the second memory cell and prior to the first time, the third data bit corresponding to the upper page of the second memory cell; and
read the one or more second data bits corresponding to the other page types of the second memory cell, wherein transferring the one or more second data bits is in accordance with reading the one or more second data bits, and wherein the one or more second data bits are read at least partially concurrently with reading the first data bit from the memory cell and at least partially concurrently with transferring the third data bit.

4. The memory system of claim 2, wherein the processing circuitry is further configured to cause the memory system to:
retrieve, in accordance with the read command, the mapping information, wherein reading the first data bit from the upper page is in accordance with the mapping information indicating that the lowest logical block address of the range of logical block addresses is mapped to a page physical address of the upper page.

5. The memory system of claim 2, wherein the memory cell is located on a first die of a memory system and the second memory cell is located on a second die of the memory system.

6. The memory system of claim 1, wherein, to write the data to the memory cell, the processing circuitry is configured to cause the memory system to:
write the data to the memory cell in accordance with an ordered sequence of page types supported by the memory cell, wherein the ordered sequence of page types is different from an order of the one or more page physical addresses.

7. The memory system of claim 6, wherein the ordered sequence of page types indicates a write to a lower page of the memory cell first, a write to the upper page of the memory cell after the write to the lower page, and a write to an extra page of the memory cell after the writes to the lower page and the upper page.

8. The memory system of claim 1, wherein the processing circuitry is further configured to cause the memory system to:
map, in accordance with the logical-to-physical mapping scheme, a middle logical block address of the range of logical block addresses to a second page physical address associated with a lower page of the memory cell; and
map, in accordance with the logical-to-physical mapping scheme, the highest logical block address of the range of logical block addresses to a third page physical address associated with an extra page of the memory cell, wherein storing the mapping information is in accordance with mapping the middle logical block address and the highest logical block address.

9. The memory system of claim 1, wherein the processing circuitry is further configured to cause the memory system to:
map, in accordance with the logical-to-physical mapping scheme, the highest logical block address of the range of logical block addresses to a second page physical address associated with a lower page of the memory cell; and
map, in accordance with the logical-to-physical mapping scheme, a middle logical block address of the range of logical block addresses to a third page physical address associated with an extra page of the memory cell, wherein storing the mapping information is in accordance with mapping the middle logical block address and the highest logical block address.

10. The memory system of claim 1, wherein the memory cell comprises a triple level memory cell that stores an upper page bit, a lower page bit, and an extra page bit.

11. A non-transitory computer-readable medium storing code comprising instructions which, when executed by processing circuitry of a memory system, cause the memory system to:
receive a write command comprising data associated with a range of logical block addresses, the range of logical block addresses comprising a lowest logical block address within the range of logical block addresses and a highest logical block address within the range of logical block addresses;
store, in response to the write command and in accordance with a logical-to-physical mapping scheme, mapping information that maps the range of logical block addresses to one or more page physical addresses, wherein the lowest logical block address is mapped to a first page physical address associated with an upper page of a memory cell in accordance with the logical-to-physical mapping scheme and in accordance with the upper page being read prior to other page types of the memory cell during a read of the memory cell; and
write the data to the memory cell in accordance with the write command and the one or more page physical addresses.

12. The non-transitory computer-readable medium of claim 11, wherein the instructions, when executed by the processing circuitry of the memory system, further cause the memory system to:
receive a read command that indicates the range of logical block addresses associated with the data stored in the memory cell;
read, at a first time and in accordance with the range of logical block addresses indicated via the read command, a first data bit from the upper page of the memory cell in accordance with the upper page being mapped to the lowest logical block address of the range of logical block addresses;
transfer, from a second memory cell at the first time, one or more second data bits corresponding to the other page types of the second memory cell, wherein the one or more second data bits are transferred from the second memory cell at least partially concurrently with reading the first data bit from the memory cell; and
transfer the first data bit from the memory cell after transferring the one or more second data bits from the second memory cell in accordance with reading the first data bit.

13. The non-transitory computer-readable medium of claim 12, wherein the instructions, when executed by the processing circuitry of the memory system, further cause the memory system to:
read, prior to the first time, a third data bit corresponding to an upper page of the second memory cell;
transfer, from the second memory cell and prior to the first time, the third data bit corresponding to the upper page of the second memory cell; and
read the one or more second data bits corresponding to the other page types of the second memory cell, wherein transferring the one or more second data bits is in accordance with reading the one or more second data bits, and wherein the one or more second data bits are read at least partially concurrently with reading the first data bit from the memory cell and at least partially concurrently with transferring the third data bit.

14. The non-transitory computer-readable medium of claim 12, wherein the instructions, when executed by the processing circuitry of the memory system, further cause the memory system to:
retrieve, in accordance with the read command, the mapping information, wherein reading the first data bit from the upper page is in accordance with the mapping information indicating that the lowest logical block address of the range of logical block addresses is mapped to a page physical address of the upper page.

15. The non-transitory computer-readable medium of claim 12, wherein the memory cell is located on a first die of a memory system and the second memory cell is located on a second die of the memory system.

16. The non-transitory computer-readable medium of claim 11, wherein the instructions to write the data to the memory cell, when executed by the processing circuitry of the memory system, cause the memory system to:
write the data to the memory cell in accordance with an ordered sequence of page types supported by the memory cell, wherein the ordered sequence of page types is different from an order of the one or more page physical addresses.

17. The non-transitory computer-readable medium of claim 16, wherein the ordered sequence of page types indicates a write to a lower page of the memory cell first, a write to the upper page of the memory cell after the write to the lower page, and a write to an extra page of the memory cell after the writes to the lower page and the upper page.

18. The non-transitory computer-readable medium of claim 11, wherein the instructions, when executed by the processing circuitry of the memory system, further cause the memory system to:
map, in accordance with the logical-to-physical mapping scheme, a middle logical block address of the range of logical block addresses to a second page physical address associated with a lower page of the memory cell; and
map, in accordance with the logical-to-physical mapping scheme, the highest logical block address of the range of logical block addresses to a third page physical address associated with an extra page of the memory cell, wherein storing the mapping information is in accordance with mapping the middle logical block address and the highest logical block address.

19. The non-transitory computer-readable medium of claim 11, wherein the instructions, when executed by the processing circuitry of the memory system, further cause the memory system to:
map, in accordance with the logical-to-physical mapping scheme, the highest logical block address of the range of logical block addresses to a second page physical address associated with a lower page of the memory cell; and
map, in accordance with the logical-to-physical mapping scheme, a middle logical block address of the range of logical block addresses to a third page physical address associated with an extra page of the memory cell, wherein storing the mapping information is in accordance with mapping the middle logical block address and the highest logical block address.

20. A method, comprising:
receiving a write command comprising data associated with a range of logical block addresses, the range of logical block addresses comprising a lowest logical block address within the range of logical block addresses and a highest logical block address within the range of logical block addresses;
storing, in response to the write command and in accordance with a logical-to-physical mapping scheme, mapping information that maps the range of logical block addresses to one or more page physical addresses, wherein the lowest logical block address is mapped to a first page physical address associated with an upper page of a memory cell in accordance with the logical-to-physical mapping scheme and in accordance with the upper page being read prior to other page types of the memory cell during a read of the memory cell; and
writing the data to the memory cell in accordance with the write command and the one or more page physical addresses.

21. The method of claim 20, further comprising:
receiving a read command that indicates the range of logical block addresses associated with the data stored in the memory cell;
reading, at a first time and in accordance with the range of logical block addresses indicated via the read command, a first data bit from the upper page of the memory cell in accordance with the upper page being mapped to the lowest logical block address of the range of logical block addresses;
transferring, from a second memory cell at the first time, one or more second data bits corresponding to the other page types of the second memory cell, wherein the one or more second data bits are transferred from the second memory cell at least partially concurrently with reading the first data bit from the memory cell; and
transferring the first data bit from the memory cell after transferring the one or more second data bits from the second memory cell in accordance with reading the first data bit.

22. The method of claim 20, wherein writing the data to the memory cell comprises:
writing the data to the memory cell in accordance with an ordered sequence of page types supported by the memory cell, wherein the ordered sequence of page types is different from an order of the one or more page physical addresses.
